(19) United States
(12) Patent Application Publication
(10) Pub. No.: US 2011/0215534 A1
(43) Pub. Date: Sep. 8, 2011

(54) PISTON RING FOR AN INTERNAL COMBUSTION ENGINE

(76) Inventors: Hans-Gunter Seiler, Bergisch Gladbach (DE); Rainer Ulrich Melzer, Leverkusen (DE)

(21) Appl. No.: 13/128,762

(22) PCT Filed: Oct. 12, 2009
(86) PCT No.: PCT/DE2009/001419

§ 371 Date: May 11, 2011

(30) Foreign Application Priority Data
Nov. 15, 2008 (DE) 10 2008 057 514.3

(51) Int. Cl. F16J 9/12; B23K 26/00

(52) U.S. Cl. 277/434; 219/121.69

(57) ABSTRACT

Piston ring for an internal combustion engine, comprising a running surface, and upper and a lower flank surface and an inner circumferential surface, wherein at least one of said surfaces is provided with at least one marking which is formed in the manner of a matrix, characterized in that the surface region which contains the marking is of brighter configuration in order to produce a background surface for the matrix than the surface regions of the piston ring which immediately adjoin in at least outside the matrix.

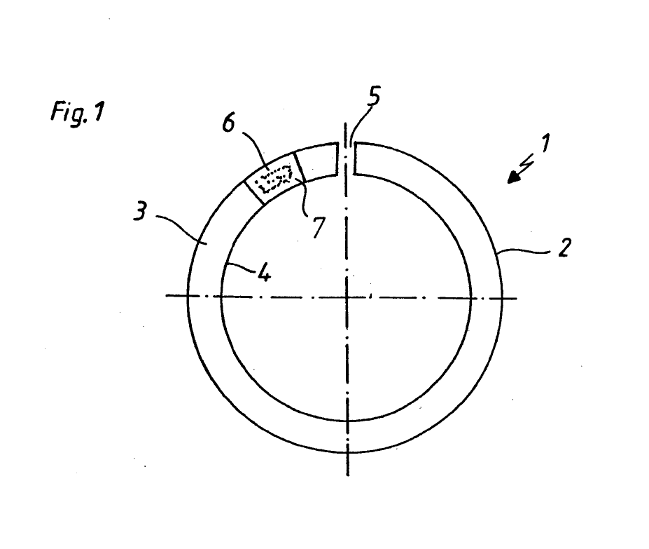

The invention relates to a piston ring for a combustion engine according to the generic part of the first Patent Claim.

A piston ring for a combustion engine including a running surface, an upper and a lower flank surface as well as an inner circumferential surface can be taken from DE 20 2007 002 756 U1, wherein at least one of these surfaces are provided with a marking constructed in the manner of a matrix.

DE 20 2005 010 612 U1 discloses a component, more preferably a piston ring for a combustion engine, with an inscription for identification of the component. The inscription is applied to a surface portion of the component subjected to little load and thus low wear. In addition to a text, the inscription also includes a barcode which is provided in encrypted form if required.

The markings, particularly data matrix codes (DMC) so far applied to the piston rings are directly applied to non-machined surface regions so that the reading out of the markings, particularly of the data matrix codes, is often rendered difficult.

The invention is based on the object of bringing about an improvement of the legibility of markings, particularly data matrix codes on piston rings.

This object is solved in that the surface region containing the marking for generating a background surface for the matrix is designed brighter than the at least outside the matrix immediately adjoining surface regions of the piston ring.

Compared with the prior art a region brightened compared with the remaining surface region can be created by smoothing the respective piston ring surface to be provided with the matrix so that the marking applied to this brightened region, particularly a data matrix code, contributes to the improvement of the read-out quality of the matrix.

According to a further idea of the invention the background surface is produced by means of laser, namely before the actual code is likewise applied by means of laser. This background surface can for example be applied through parallel lines. If the background pattern is to have a rectangular cross-sectional shape the lines can for example be applied diagonally. Textures of a different type however are likewise conceivable (horizontal or vertical parallel lines, cross structure or the like).

The subject of the invention is shown in the drawing by means of an exemplary embodiment and is described as follows:

The only FIGURE shows a piston ring 1 including a running surface 2, an upper flank surface 3 noticeable in this representation and an inner circumferential surface 4. Additionally noticeable is the joint 5 of the piston ring 1. On the upper flank surface 3 an only schematically indicated marking 6 is located, which in this example is applied to the upper flank surface 3 in the region of the joint 5. The marking 6 is designed as machine-readable data matrix code. The surface region 7 containing the marking 6 was subjected to a laser processing before the application of the marking 6, so that a background surface is formed which compared with the adjoining surface regions of the piston ring I is designed brighter. Following the application of the marking 6 the latter can be better detected visually and can be read out more easily.

1-6. (canceled)

7. A piston ring for a combustion engine including a running surface, an upper and a lower flank surface as well as an inner circumferential surface;
at least one of said surfaces being provided with at least one marking in a background surface region of said surfaces in the form of a matrix:
wherein said background surface region containing said at least one marking is brighter than a surface region adjacent said background surface region and that said background surface region is created through laser smoothing.

8. The piston ring according to claim 7, wherein said background surface is formed through lines running parallel to one another.

9. The piston ring according to claim 8, wherein said lines with an approximately rectangularly designed background surface run diagonally of said rectangular design.

10. The piston ring according to claim 7, wherein said marking designed as data matrix code is applied to the background surface by means of laser.

11. A method of marking a piston ring of a combustion engine with an indicia, comprising laser smoothing a background surface region of at least one of a running surface, an upper surface, a lower flank surface and an inner circumferential surface such that said laser smoothed background surface region is brighter than an adjacent surface region of the at least one surface on which the background surface region is created; and marking the laser smoothed background surface with an indicia.

12. The method of claim 11, wherein the indicia is in the form of a matrix.

13. The method of claim 11, wherein the background surface region is made in the form of a plurality of parallel lines created by the laser smoothing operation.

14. The method of claim 13, wherein the plurality of parallel lines are formed to provide a rectangular shape to the background surface region.

15. The method of claim 14, wherein the plurality of parallel lines are oriented diagonally with respect to the rectangular-shaped background surface region.

16. The method of claim 11, wherein the indicia is applied by means of a laser.
